(19) United States
(12) Patent Application Publication
(10) Pub. No.: US 2012/0201170 A1
(43) Pub. Date: Aug. 9, 2012

(54) Backhaul Optimization For Traffic Aggregation

(75) Inventors: Lev B. Sofman, Allen, TX (US); Louise D. Gabriel, Swindon (GB); Michel Grech, London (GB)

(73) Assignee: Alcatel-Lucent USA Inc., Murray Hill, NJ (US)

(21) Appl. No.: 13/246,957

(22) Filed: Sep. 28, 2011

Related U.S. Application Data
(60) Provisional application No. 61/440,149, filed on Feb. 7, 2011.

(51) Int. Cl. H04L 12/28

(52) U.S. Cl. 370/256

(57) ABSTRACT

An apparatus and method for producing a traffic aggregation map for a telecommunications network where the network has at least one aggregation node and a plurality of access nodes. A computing device receives information regarding the identity of each node in the network and determines cost information relating to pairs of the nodes. The cost information may be calculated by the computing device or received as input, or a combination of the two. Cost information is also assigned for each pair consisting of an aggregation node and a super node, which is not one of the aggregation or access nodes. To produce the map, the computing device calculates a minimum spanning tree interconnecting all of the nodes including the super node. Disregarding in most cases the connections terminating at the super node, the remaining connections are displayed on a display device, preferably superimposed on a geographic map.

### CROSS-REFERENCE TO RELATED APPLICATIONS

The present disclosure is related to and claims priority from U.S. Provisional Patent Application Ser. No. 61/440,149, entitled Backhaul Optimization for Traffic Aggregation and filed on 7 Feb. 2011, the entire contents of which are incorporated by reference herein.

### TECHNICAL FIELD

The present invention relates generally to the field of communications networks, and, more particularly, to a method and apparatus for producing a traffic aggregation map and determining optimal configuration or configurations for backhaul traffic aggregation in a communications network.

### BACKGROUND

A communications network provides, among other things, a way for residential and commercial subscribers to receive audio and video programming, make telephone calls, and connect with the Internet. A subscriber may connect with the network by fiber optic cable, wire, or in some cases a wireless channel to a network access point. Each subscriber may have any number of home devices such as computers and telephones that communicate via the communications network. Communications to and from the subscriber's premises are governed by standard protocols that are designed to regulate when and how each network entity transmits and receives data to permit them all to use the network and provide certain levels of quality.

The level of data traffic in many communications networks is rapidly increasing, and the networks are always searching for ways to become more efficient and provide broadband service to a large number of subscribers. One way to do this is to aggregate backhaul traffic as it traverses the network from subscribers to a central office or the core network. Aggregation can be accomplished, for example, in network nodes that have a broadband connection to a desired destination. Other nodes may then be connected with these aggregation nodes by smaller-capacity channels. For example, access nodes may provide network connections for a number of subscribers and are located throughout the network coverage area. Rather than running a line all the way to the central office or core network, a number of access nodes may be connected with an aggregation node, which aggregates the received traffic (perhaps along with subscriber traffic it itself receives).

Naturally, there is also a need to determine the most cost effective design or designs for handling backhaul traffic aggregation in a given telecommunications network. This is of course helpful for all networks, but it is especially advantageous for existing networks in rural or semi-rural areas. In such an environment, the nodes may be more widely and less regularly dispersed, and the number of subscribers supporting the network may be much smaller than in a crowded urban area.

Accordingly, there has been and still is a need to address the aforementioned shortcomings and other shortcomings associated with backhaul traffic aggregation. These needs and other needs are satisfied by the present invention.

Note that the techniques or schemes described herein as existing or possible are presented as background for the present invention, but no admission is made thereby that these techniques and schemes were heretofore commercialized or known to others besides the inventors.

### SUMMARY

The present invention is directed to a manner of producing a traffic aggregation map for a communications network with the goal of optimizing backhaul traffic aggregation.

In one aspect, the present invention provides a method for producing a traffic aggregation map for a telecommunications network having at least one aggregation node and a plurality of access nodes including the steps of receiving in a computing device information representing the identity and location of the at least one aggregation node and plurality of access nodes, determining cost information associated with pairs selected from the at least one aggregation node and a plurality of access nodes, assigning a cost to each pair consisting of an aggregation node and a super node, wherein the super node is an identity not the at least one aggregation node or from the plurality of access nodes, and calculating by a processor associated with the computing device a minimum spanning tree including the super node, the at least one aggregation node, and the plurality of access nodes.

The method may further include transmitting to a display device in communication with the computing device a traffic aggregation may comprising at least a portion of the calculated minimum spanning tree. The method may further include generating a traffic aggregation map that also includes a geographic map for presenting with the connected nodes of the minimum spanning tree portion. The super node and MST (minimum spanning tree) connections terminating at the super node are not normally presented with the traffic aggregation map.

The method may further include receiving cost information at the computing device or computing cost information, or both. Determining cost information may include calculating distances between the pairs of nodes based on the location information using, for example, a Euclidean distance or great circle calculation.

In another aspect, the present invention provides an apparatus for producing a traffic aggregation map including a CPU (central processing unit), a memory device in communication with the CPU, a cost determiner for determining a cost value associated with a pair of nodes selected from a plurality of nodes comprising at least one aggregation node and a plurality of access nodes, wherein the cost determiner is configured to assign a cost to each pair consisting of an aggregation node and a super node, wherein the super node is an identity not the at least one aggregation node or from the plurality of access nodes, and an MST calculator for calculating an MST including the plurality of nodes based on the cost values determined by the cost determiner. The apparatus may further include a distance calculator for calculating a distance cost associated with pairs of nodes based on location information describing the location of each of the nodes and a display generator configured to generate a traffic aggregation map based on an MST calculated by the MST calculator.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating the spatial relationship of aggregation nodes and access nodes in telecommunications network;

FIGS. 2a through 2c are simplified schematic diagrams illustrating possible aggregation paths for sub tree;

FIG. 3 is a flow diagram illustrating a method of producing a traffic aggregation map in accordance with an embodiment of the present invention;

FIG. 4 is a flow diagram illustrating a method of producing a traffic aggregation map in accordance with an embodiment of the present invention;

FIG. 5 is a flow diagram illustrating a method of calculating a minimum spanning tree for a communications network according to an embodiment of the present invention;

FIG. 6 is a flow diagram illustrating a method of displaying a backhaul traffic aggregation map for a communications network according to an embodiment of the present invention; and

FIG. 7 is an apparatus for producing a traffic aggregation map according to an embodiment of the present invention.

### DETAILED DESCRIPTION

The present invention is directed to a manner of producing a backhaul traffic aggregation map for a telecommunications network. The goal is to determine the optimum way to interconnect a number of, for example, access nodes with the aggregation nodes of the network. The method and system are expected to be advantageously employed in rural or semi-rural areas having a geographically-dispersed population, although it can be employed in other networks as well. The actual nodes of the network may be physically installed already, but this is not necessarily the case.

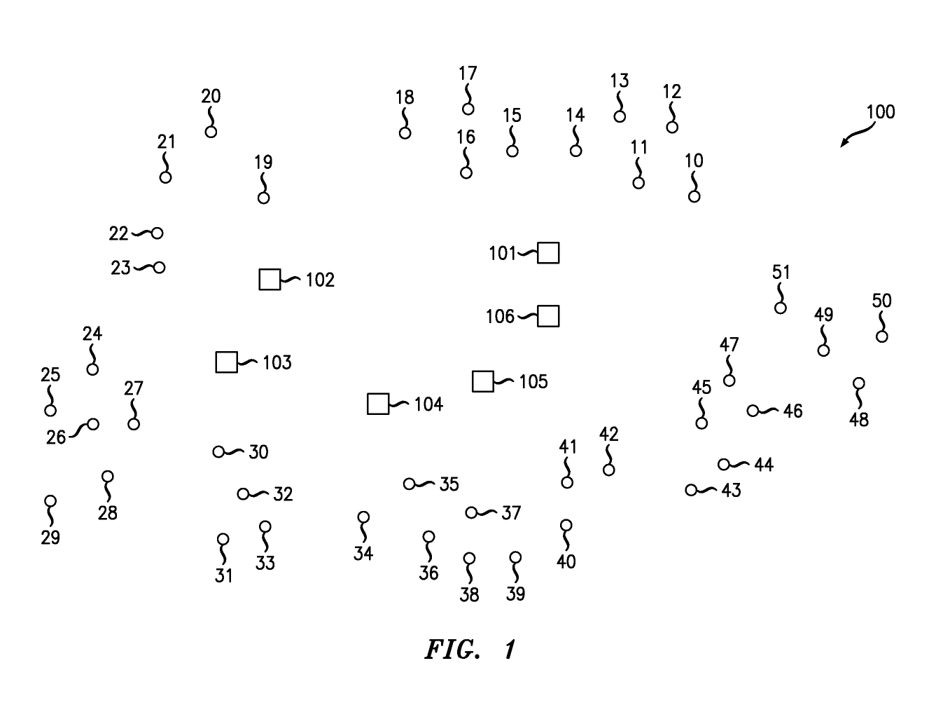

An exemplary network is illustrated in FIG. 1. FIG. 1 is a simplified schematic diagram illustrating the spatial relationship of aggregation nodes and access nodes in telecommunications network 100. For the purposes of illustration, it is presumed that this is an existing network but for clarity any existing interconnections between nodes are not shown.

As used herein, an aggregation node is one that has (actual or anticipated) broadband connectivity with a CO (central office) or the core network (not shown in FIG. 1), meaning that it has the capacity to be utilized for aggregating communications traffic from other nodes. Specifically, traffic from a number of access nodes may be advantageously aggregated in the aggregation node for transmission toward the core network or some other destination over existing (or planned) communication lines. Examples of typical aggregation nodes are cellular network towers or HSPNs (high speed public networks) that are already deployed for schools or other public institutions.

Examples of typical access nodes are DSLAMs (digital subscriber line access multiplexors) or street cabinets to which subscribers may be directly connected. In FIG. 1, the access nodes are depicted as small circles and referred to as numbers 10 through 51. The aggregation nodes are depicted as rectangles and referred to by numbers 101 through 106.

Note that notwithstanding the examples provided above, no specific type of apparatus is required to be or be considered an access node or an aggregation node unless explicitly recited in a particular claim. Other types of devices than those listed above may constitute network nodes. For example, the present invention may be applied to backhaul traffic between COs. In such cases the aggregation nodes will be those identified as such when the invention is implemented. Note also that for convenience the aggregation nodes 101 through 106 are shown as centrally situated and surrounded by access nodes 10 through 51. Actually networks may vary widely in layout and the present invention may still be implemented.

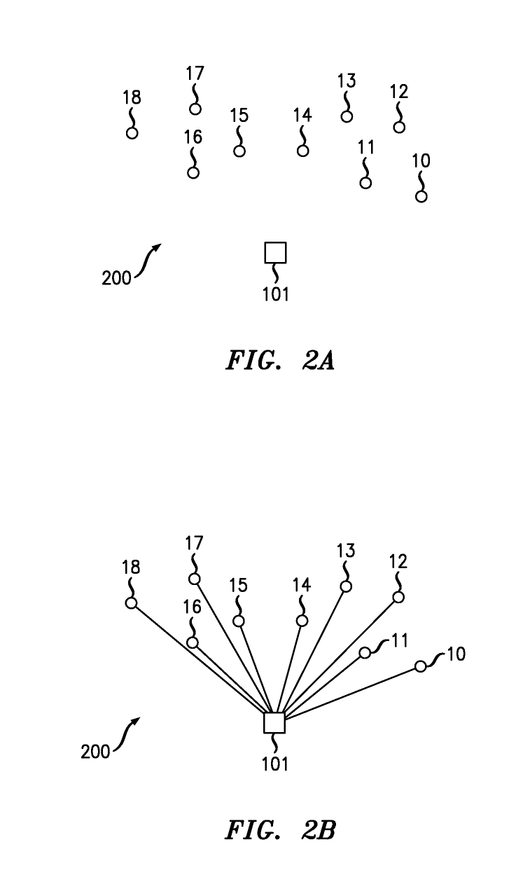

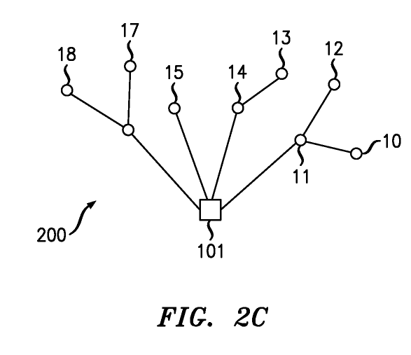

As mentioned above, the goal is to produce an optimum aggregation map for the telecommunications network so that the traffic backhaul may be accomplished at or near the lowest possible cost. An illustration of this is provided with reference to FIGS. 2a through 2c. FIGS. 2a through 2c are simplified schematic diagrams illustrating possible aggregation paths for sub tree 200. As used herein, a sub tree is considered a collection of the access node or nodes aggregating into an aggregation node. In most cases, a sub tree will have a single aggregation node, although this is not necessarily true in all cases.

FIG. 2a shows aggregation node 101 and nine access nodes 10 through 18. Here it is noted that for purposes of illustration, sub tree 200 includes aggregation node 101 and nearby access nodes. No implication is intended, however, that that access nodes 10 though 18 of network 100 would always be optimally a part of this same sub tree. Nevertheless, if access nodes 10 through 18 are part of the same sub tree, there are different routes for traffic aggregations through aggregation node 101. In one scenario, the access nodes of a sub tree may each connect with the closest aggregation node directly, as shown in FIG. 2b. This may be referred to as a star configuration. Although some of the benefits of backhaul traffic aggregation may be achieved in this fashion, it may not be the most efficient manner of connecting the access nodes for this purpose. FIG. 2c, for example, illustrates the access nodes 10 through 18 connected to the aggregation node 101 in what may be referred to as a cluster configuration. As can be seen in FIG. 2c, some of the traffic from a given access node will be aggregated in another access node prior to aggregation of all traffic from the sub tree 200 in the aggregation node 101. For example, access node 11 aggregates the traffic from access nodes 10 and 12, along with its own traffic, for transmission to aggregation node 101.

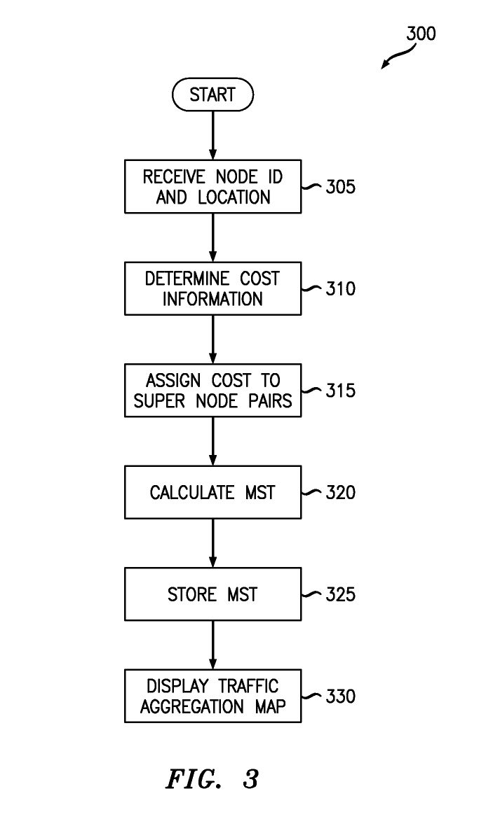

Although FIG. 2c is intended to be illustrative of an optimized sub tree, the same configuration may not be realized in all similar sub trees. In some cases, an access node may be placed in a sub tree that does not terminate in the aggregation node nearest the access node. A method of the present invention, which seeks to optimize the formation and configuration of sub trees for communications networks, will now be explained in reference to FIG. 3.

FIG. 3 is a flow diagram illustrating a method 300 of producing a traffic aggregation map in accordance with an embodiment of the present invention. At START it is presumed that that apparatus necessary for performing method 300 is available and operational according to this embodiment of the invention. The process then begins with the receipt of information representing the identity and location of each access node and each aggregation node in the telecommunications network that will be present on the aggregation map (step 305).

The identity can be any value that uniquely identifies the node, but it should also indicate in some way whether the node is an access node or an aggregation node. This node type information may be a function of the value of the unique identifier itself or it may be received as a separate value.

The location information may likewise be received in a number of ways, though preferably it is received as latitude and longitude or an equivalent measurement, or by reference to locations similarly referred to on a geographical map of the network coverage area or a part thereof. In other words, the location information describes either a geographical location on the face of the earth or a location on a geographical map. Note, however, that while such location information is necessary to produce a visual geographical map of the network, it is not required in all embodiments of the present invention.

The process then continues with the determination of cost information (step 310). The cost information is associated with pairs of nodes, and reflects the expense of forming a backhaul connection in the aggregation network. Generally speaking, the costs will include the cost of the connection, for example laying a fiber optic cable, as well as the additional cost of the necessary equipment at the node itself.

Note that for implementing the present invention a node may be existing or simply a planned installation. When determining cost, however, it is preferable to use only the incremental additional expense involved with traffic aggregation and not the entire new installation costs. This may vary from one implementation to the next.

Determining the cost information may involve simply receiving and storing the information in the computing device producing the map, or it may be calculated based on the location information provided. In many cases, a combination of both may be used. Some information may be input by a user, for example, or retrieved over a network connection. In some implementations, the cost of equipment upgrades may also be calculated from node configuration information previously provided. The cost is normally but not necessarily determined in monetary terms.

In accordance with this embodiment the present invention, cost information is also assigned (step 315) to pairs consisting of an aggregate node and a super node. The super node is typically a node identified just for this purpose, and is preferably not an aggregation node or access node that was identified in step 305. The super node is used for construction of the traffic aggregation map and need not correspond to any particular location, though a location may be assigned to it in the mapping process. The super node is often not a functioning node of the communications network. In step 315 of this embodiment, a zero or nominal cost value is assigned to any connection terminating at the super node.

In the embodiment of FIG. 3, the computing device then calculates an MST (minimum spanning tree) connecting all of the nodes (step 320). The MST calculation uses the connections between nodes as edges and the nodes themselves, including the super node, as vertices. Any known MST algorithm may be used for the calculation, for example Prim's or Kruskall's. The results of the MST calculation are then stored in a memory device accessible to the computing device (step 325). Note that as used herein, “memory device” connotes a physical, non-transitory memory device.

In this embodiment, a traffic aggregation map is then sent for display (step 330) on a display device associated with or a part of the computing device. The displayed traffic aggregation map includes all or a portion of the minimum spanning tree calculated in step 320, except that the super node and any connections terminating there are normally not displayed.

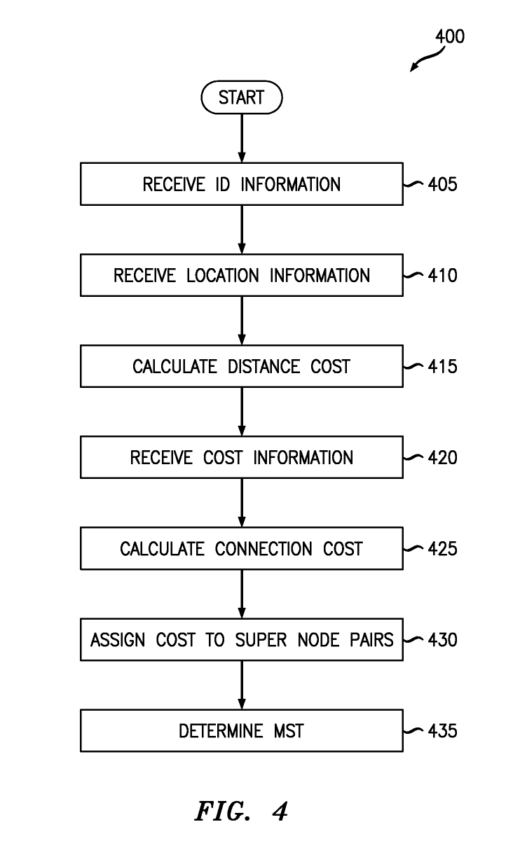

FIG. 4 is a flow diagram illustrating a method 400 of producing a traffic aggregation map in accordance with an embodiment of the present invention. At START it is presumed that that apparatus necessary for performing method 400 is available and operational according to this embodiment of the invention. The process then begins with the receipt of information (step 405) identifying each node of the telecommunications network that is to be incorporated into the aggregation map, and indicates which nodes are to be considered aggregation nodes. Of course, not all of the nodes of the actual network need be identified or placed on the map. But in most implementations they will be identified absent some reason for their exclusion, for example they may be targeted for decommissioning or replacement. On the other hand, as mentioned above, where nodes are planned rather than currently installed, they may be identified as such for placement on the map.

In this embodiment, location information relating to the identified nodes is received (step 410). Again, the location information may be received in a variety of ways so as to define the position of the node in relation to a geographical location or relative to the other nodes of the network. The computing device then calculates the distance cost associated with selected pairs of nodes (step 415). The distance cost may be calculated in a number of ways.

Initially, of course, the physical distance between the nodes is calculated. This may be the Euclidean distance, that is, the length of a straight line connected the two nodes. In other implementations a great circle calculation may be used to more accurately determine the distance between the two nodes along the surface of the earth. Once the distance is calculated, a per unit distance value may be applied to find the distance cost related to a particular pair of nodes. Note that is some implementations distance cost is the only cost used and in that case of course no per-unit factor is necessary. In other cases, the per-unit value can be varied according to the location of the nodes in a given pair.

In the embodiment of FIG. 4, other costs are taken into account and so the method 400 includes receiving additional cost information (step 420). The additional cost information will vary from one implementation to another, but in many cases will include the cost of additional equipment needed for a given node to aggregate backhaul traffic should it be required to do so. In the case of planned or potential nodes, it may also include some or all of the cost of the new installation. In some embodiments, the additional cost information may also include information relating to pairs of nodes, for example that two access nodes are already connected and equipped in such a manner as to permit backhaul aggregation. In some embodiments, the additional cost information may be used in preference to calculated distance cost, for example to account for special circumstances or existing capacity.

In the embodiment of FIG. 4, the computing device then calculates the connection cost (step 425) related to selected pairs of nodes. Again, the selected nodes may be all or only a portion of the nodes. The connection cost represents the cost to provide a backhaul aggregation link between the two nodes of a given pair. In this context, it is noted that if the identification information received at step 405 or the cost information received at step 420 or both indicate that neither the nodes nor the connection between them require additional modifications, then only a nominal connection cost may be assigned to the pair, overriding any other cost calculation factors.

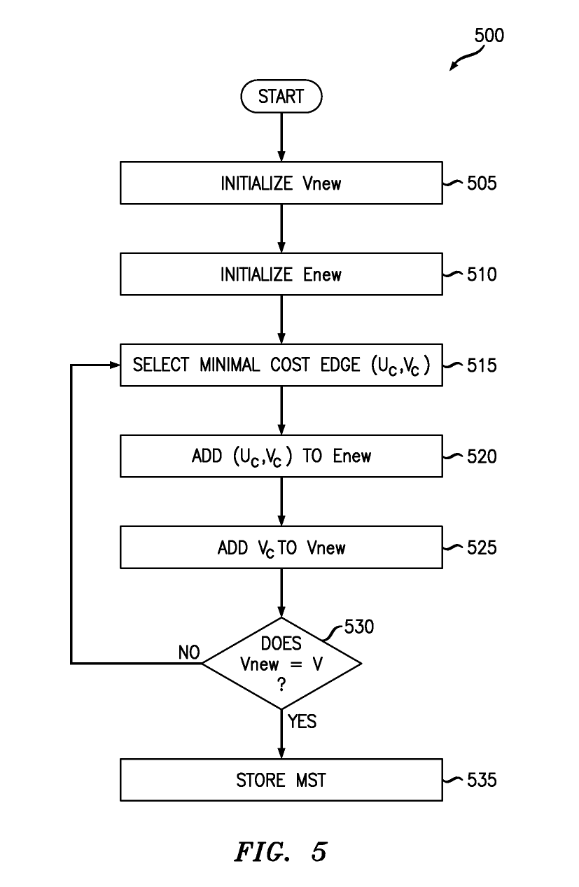

In accordance with this embodiment of the present invention, as with the method 300, described above, a zero or nominal cost is assigned (step 430) to each pair of nodes consisting of an aggregation node and a super node. It is preferred that each aggregation node is so paired, and that the cost of its connection to the super node is assigned as zero. A minimum spanning tree connecting the nodes of the network, including the super node, is then calculated (step 435). As mentioned above, any known algorithm for minimum spanning tree calculation may be used. An exemplary process is shown in FIG. 5.

FIG. 5 is a flow diagram illustrating a method 500 of calculating a minimum spanning tree for a communications network according to an embodiment of the present invention. At START it is presumed that that apparatus necessary for performing method 500 is available and operational according to this embodiment of the invention. In this embodiment, the minimum spanning tree is calculated as follows. A set V_{new} is initialized (step 505) to include the super node and the aggregation nodes. All aggregation nodes are included in V_{new} absent some reason to exclude one from the calculation. A set E_{new} is initialized (step 510) to include all node connections, that is, connections between the super node and the access nodes, and connections between aggregation nodes. Again, nodes are the vertices of the minimum spanning tree calculation and the connections between them are edges.

In this embodiment, an edge is defined by two vertices, which may be generically referred to here as (u, v). After V_{new} and E_{new} are initialized at step 505, an edge (u_{c}, v_{c}) with minimal cost is selected (step 515) such that u_{c} is in the set V_{new} and v_{c} is not. If there are multiple edges with the same cost, any of them may be chosen. The chosen edge (u_{c}, v_{c}) is added (step 520) to E_{new}, and its vertex v_{c} is added (step 525) to the set V_{new}. A determination is then made (step 530) as to whether V_{new}=V, that is, whether each of the vertices v in V have been added to the set V_{new}. If not, the process returns to step 515 and another edge (u_{c}, v_{c}) is selected.

In this embodiment, if it is determined at step 530 that V_{new}=V, the minimum spanning tree is described by sets E_{new} and V_{new} and the calculated minimum spanning tree is stored (step 535) as the traffic aggregation map in a memory device in or accessible to the computing device.

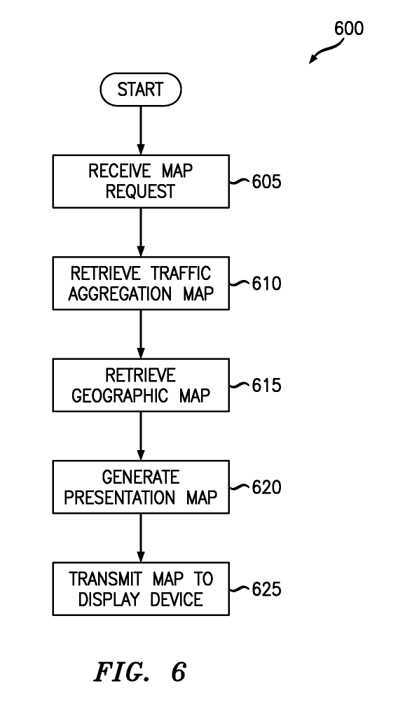

The traffic aggregation map may be used in a variety of ways, for example as shown in FIG. 6. FIG. 6 is a flow diagram illustrating a method 600 of displaying a backhaul traffic aggregation map for a communications network according to an embodiment of the present invention. At START is presumed that that apparatus necessary for performing method 600 is available and operational according to this embodiment of the invention. When a computing device with a backhaul traffic aggregation map created and stored, for example, as described above, receives a request (step 605) to display a traffic aggregation map, it retrieves (step 610) all or part of the traffic aggregation map stored in the memory device.

In the embodiment of FIG. 6, the computing device then retrieves a geographic map of the relevant region (step 615), either from a local memory device or via a network connection to, for example, the Internet. Using the location information previously received, a presentation is generated (step 620) that includes the retrieved geographic map and the selected portions of the traffic aggregation map. In a preferred embodiment, the nodes of the selected portion and the connections between them are shown superimposed on the retrieved geographic map. Typically, however, neither the super node nor connections terminating at it are included in the display. The generated map is then sent to a display device (step 625) for presentation. Note that the selected portion of the map may be the entire communications network, although in most cases the network is very large and displaying less than all of it may be desirable. For example, a map corresponding to one sub tree could be sent to the display device. The generated display may include the entire network, with only a single sub tree being sent at one time for presentation until a request for the next or a particular sub tree is received (not shown in FIG. 6).

In an alternate embodiment (not shown), a geographic map is either not used or optional, at the discretion of a user. In that case the traffic aggregation map may itself be sent to the display, although preferably with location information (such as latitude, longitude or map coordinates) included in some fashion. This location information could be displayed at each node presented or listed in a table. Naturally, printed maps may also be produced, for example in either in graphic or tabular formats, or a combination of the two.

Note that the sequences of operation illustrated in FIGS. 3 through 6 represent exemplary embodiments; some variation is possible within the spirit of the invention. For example, additional operations may be added to those shown in the figures, and in some implementations one or more of the illustrated operations may be omitted. In addition, the operations of the methods may be performed in any logically-consistent order unless a definite sequence is recited in a particular embodiment.

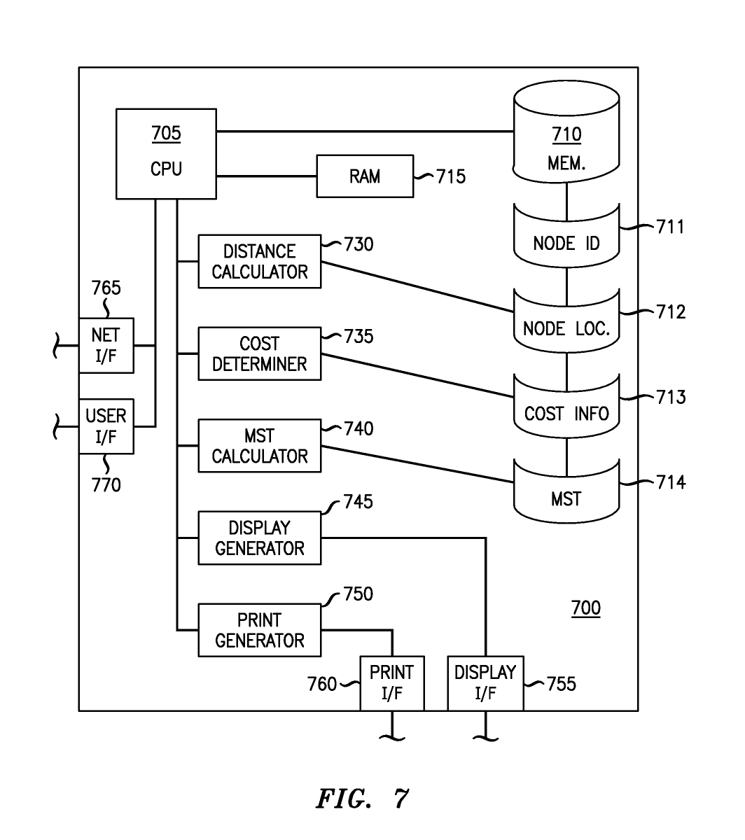

FIG. 7 is an apparatus 700 for producing a traffic aggregation map according to an embodiment of the present invention. In accordance with the present invention, apparatus 700 has several functions that are described herein. Apparatus 700 is typically implemented as a physical processor executing instructions stored as software in a non-transitory medium. In other embodiments, the apparatus 700 may be implemented as a combination of executable software and hardware such as an ASIC. The apparatus may be a standalone computing device or incorporated in a multifunction apparatus that performs other duties as well.

In the embodiment of FIG. 7, apparatus 700 includes a processor, or CPU (central processing unit), 705 for controlling the operation of the other components of apparatus 700. CPU 705 can access both a mass storage memory device 710 and a RAM (random access memory) 720. Both memory device 710 and RAM 720 are physical memory devices that operate, in this embodiment, under the control of CPU 705 or a peripheral device. Memory device 710 is for storage of, among other things, program instructions for the operations of apparatus 700 and data or information used by apparatus 700 in execution of the present invention. Note that in other embodiments, memory device 710 may be located in a device physically separate from CPU 705. RAM 720 provides temporary storage during the operation of apparatus 700 and is normally though not necessarily located within apparatus 700.

In the embodiment of FIG. 7, shown separately are data storage for node identity 711 and node location 712 for storing this information when it is received by the apparatus 700. Similarly, storage for cost information 713, both as received and as calculated by apparatus 700, is included, as is data storage for calculated MSTs (minimum spanning trees) 714.

In this embodiment, distance calculator 730 determines the distance between pairs of nodes when location related to each node is made available. Cost determiner 735 uses cost information received and calculated cost information to determine the costs associated with each node-to-node connection. MST (minimum spanning tree) calculator 740 uses the cost information to calculate one or more minimum spanning trees for the communications network. A display generator 745 uses the calculated minimum spanning tree or trees to generate traffic aggregation maps for display. A report generator 750 is also available for similarly generated reports and maps for sending to a printing device.

Apparatus 700 of FIG. 7 also includes a display interface 755 for sending traffic aggregation maps and reports to a display devices for presentation of the traffic aggregation maps produced, and a printer interface 760 for sending generated reports and maps to a printer. A network interface 765 permits access to networked devices and other networks. A user interface 770 allows a user to provide input and view results. It is noted that while these interfaces are separately shown for the purpose of illustration, in some embodiments they may be arranged differently.

The apparatus 700 of FIG. 7 is only one configuration of a computing device for producing backhaul traffic aggregation maps according to the present invention. In alternate embodiments the various components of apparatus 700 may be further distributed or integrated with one another. It is not necessary that they all reside on the same physical device unless explicitly recited in a particular embodiment. Additional components may of course be present in apparatus 700, and in some embodiments the components illustrated in FIG. 7 may not be present.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for producing a traffic aggregation map for a telecommunications network comprising at least one aggregation node and a plurality of access nodes, the method comprising:
receiving in a computing device information representing the identity and location of the at least one aggregation node and plurality of access nodes;
determining cost information associated with pairs selected from the at least one aggregation node and a plurality of access nodes;
assigning a cost to each pair consisting of an aggregation node and a super node, wherein the super node is an identity not the at least one aggregation node or from the plurality of access nodes;
calculating by a processor associated with the computing device a minimum spanning tree including the super node, the at least one aggregation node, and the plurality of access nodes.

2. The method of claim 1, wherein the pairs selected include pairing each access node with each other node except the super node.

3. The method of claim 1, further comprising transmitting to a display device in communication with the computing device a traffic aggregation map comprising at least a portion of the minimum spanning tree.

4. The method of claim 3, wherein the traffic aggregation map does not include the super node or connections terminating at the super node.

5. The method of claim 3, wherein the traffic aggregation map further comprises a geographic map.

6. The method of claim 5, further comprising retrieving the geographic map.

7. The method of claim 3, wherein the traffic aggregation map comprises a single aggregation node and any access nodes communicating with it along a path that does not pass through the super node.

8. The method of claim 1, wherein determining cost information comprises receiving cost information at the computing device.

9. The method of claim 1, wherein determining cost information comprises calculating distances between the pairs of nodes based on the location information.

10. The method of claim 9, wherein the distance calculates the Euclidean distance for at least some pairs of nodes.

11. The method of claim 9, wherein the distance calculates the Great Circle distance for at least some pairs of nodes.

12. The method of claim 9, wherein the cost associated with pairs of nodes is based solely on the distance calculation.

13. The method of claim 1, wherein the cost assigned to each pair consisting of an aggregation node and a super node is zero.

14. The method of claim 1, wherein determining cost information comprises assigning a cost of zero to any pair of nodes that is already connected.

15. An apparatus for producing a traffic aggregation map comprising:
a CPU (central processing unit);
a memory device in communication with the CPU;
a cost determiner for determining a cost value associated with a pair of nodes selected from a plurality of nodes comprising at least one aggregation node and a plurality of access nodes, wherein the cost determiner is configured to assign a cost to each pair consisting of an aggregation node and a super node, wherein the super node is an identity not the at least one aggregation node or from the plurality of access nodes; and
an MST calculator for calculating an minimum spanning tree including the plurality of nodes based on the cost values determined by the cost determiner.

16. The apparatus of claim 15, further comprising a distance calculator for calculating a distance cost associated with pairs of nodes based on location information describing the location of each of the nodes.

17. The apparatus of claim 15, further comprising a display generator configured to generate a traffic aggregation map based on an minimum spanning tree calculated by the minimum spanning tree calculator.

18. The apparatus of claim 17, wherein the display generator is further configured to include a geographic map in the generated traffic aggregation map.
